(19) United States
(12) Patent Application Publication
(10) Pub. No.: US 2007/0165196 A1
(43) Pub. Date: Jul. 19, 2007

(54) Display frame for changing of multiple pictures

(75) Inventor: Tony Chuang, Taipei Hsien (TW)

Correspondence Address: BRUCE H. TROXELL;SUITE 1404, 5205 LEESBURG PIKE, FALLS CHURCH, VA, 22041, US

(73) Assignee: Trusty Industrial Inc.

(21) Appl. No.: 11/333,354

(22) Filed: Jan. 18, 2006

(51) Int. Cl. G03B 21/00

(52) U.S. Cl. 353/120

(57) ABSTRACT

A display frame for changing of multiple pictures used as a picture frame or an advertisement billboard, it comprises in an assembly of a framework, multiple pictures, a grating plate and a movably mounted motor; the pictures and the grating plate are assembled in the framework, a leaf of specific shape is driven by the motor to change the positions or angular positions of a picture sheet or the grating plate, thereby effects that the pictures on the grating plate are automatically changed and entirely presented in prolonged times are achieved.

### BACKGROUND OF THE INVENTION

1. Field of the Invention

The present invention is related to a display frame for changing of multiple pictures used as a picture frame or an advertisement billboard, and especially to a display frame for multiple pictures in which the multiple different pictures can fast change automatically, and the pictures can be entirely presented for a long time.

2. Description of the Prior Art

Products each with the effect of changing of two or more than two pictures manufactured according to the principle of refraction of a cylindrical mirror grating or manufactured by the principle of visual line illusion of a printed grating film are more and more popularized; each product with multiple changing pictures originally has a grating plate clung on a picture sheet, and then a viewer moves to a different angular viewing position, the changing of the multiple pictures can thus be seen.

In order to meet the requirement of advertisement to elevate the visual effect and to attract people's eye sights, there have been various automatically picture changing frames developed. Although the mechanisms of them are more or less different, they all observe a principle, that is, in each case, the grating plate is separated from a picture sheet, a motor is provided to drive either of the grating plate and picture sheet, so that a viewer stay at a position unmoved can see nonstop changing of the pictures.

The structure has a defect: That is, a motor is rotated with a fixed rotational speed, when an eccentrically rotating round member with an axle as a rotating center drives the different pictures to make changing, the times for entirely presenting the different pictures before they get into the processes of cross changing are short, the important effect for customers to clearly see the contents of the advertisements is unable to get.

FIGS. 1A to 1E are schematic views showing the operations of a conventional motion frame for two pictures, wherein a round pushing leaf 503 around an eccentrically rotating axle 504 of a motor is placed at an opening of a moved article 501, the article 501 to be moved can be connected with a grating plate or the picture sheet for angular changing.

In the drawings of FIGS. 1A to 1E, 502 indicates the horizontal line at the center of the rotating axle 504 of the motor, in the drawings, the states of moving by rotating clockwise of the article 501 which is moved every 90 degrees around the rotating axle 504 of the motor are shown. We can see that the article 501 all the way is moved gradually following the rotating of the rotating axle 504; i.e., the grating plate or the picture sheet change their angular presenting positions gradually to make the pictures change. By virtue that such a conventional structure takes advantage of the rotating eccentric pushing leaf 503 to render the multiple different pictures always to keep the processes of slowly cross changing, so that the times for entirely presenting the pictures are short, the effect for presenting the entire pictures in predetermined times can not be achieved.

### SUMMARY OF THE INVENTION

The main improvement of the present invention is to provide a leaf with a specific shape and being driven by a motor, the leaf with a specific fan shape is used to achieve the effect that the pictures are automatically changed and entirely presented in long times; and the leaf can be made of plastic or metal etc. The fan shaped leaf includes two or more than two semicircles of different radii or non semicircular shapes all with same center in order to shorten the times for changing their presenting positions, thus the times for entirely presenting the pictures are lengthened.

Another improvement of the present invention is to provide a device on the motor to adjust the level of the motor, thus the initial angular position of the grating plate can be adjusted to allow the first one of the pictures to be entirely presented.

The present invention will be apparent after reading the detailed description of the preferred embodiment thereof in reference to the accompanying drawings.

### BRIEF DESCRIPTION OF THE DRAWINGS

FIGS. 1A to 1E are schematic views showing the operations of a leaf to change pictures of a conventional motion frame;

FIG. 2 is a front view of an advertisement billboard for changing of multiple pictures of the present invention;

FIG. 3 is a sectional side view of the advertisement billboard for changing of multiple pictures of the present invention;

FIG. 4A is a front view showing a back plate, a picture sheet and a grating plate of a picture frame of the present invention in assembling;

FIG. 4B is a perspective view showing the back plate, the picture sheet and the grating plate of the picture frame of the present invention to be assembled;

FIG. 5 is a plan view showing a specific fan shaped leaf for the picture frame and the advertisement billboard for changing of pictures of the present invention;

FIGS. 6A to 6E are schematic views showing the operations of changing pictures of the leaf of FIG. 5;

FIG. 7 is a plan view showing another fan shaped leaf for the picture frame and the advertisement billboard for changing of pictures of the present invention;

FIG. 8 is a plan view showing a further fan shaped leaf for the picture frame and the advertisement billboard for changing of pictures of the present invention applicable to changing of three pictures;

FIGS. 9 and 10 are sectional side views for comparison with each other of the advertisement billboard for changing of multiple pictures of the present invention, showing a device used to adjust the level and position of a motor, the two drawings show different angular positions of the grating plate before and after adjustment.

FIG. 11 is a schematic sectional side view of another embodiment of advertisement billboard for changing of multiple pictures of the present invention;

FIG. 12A is a schematic anatomic view of a separable dual fan shaped leaf of the present invention;

FIG. 12B is a plan view after assembling of FIG. 12A;

FIG. 12C is a plan view showing a main leaf of FIG. 12A;

FIG. 12D is a plan view showing a secondary leaf of FIG. 12A;

FIG. 13A is a schematic anatomic view of a separable triple fan shaped leaf of the present invention;

FIG. 13B is a plan view after assembling of FIG. 13A.

### DETAILED DESCRIPTION OF THE PREFERRED EMBODIMENT

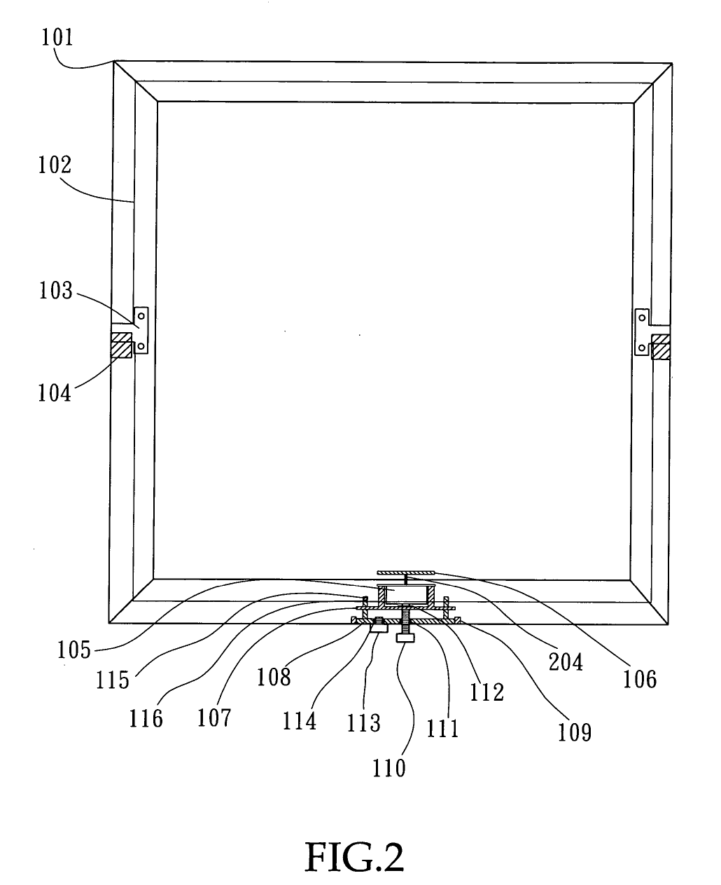

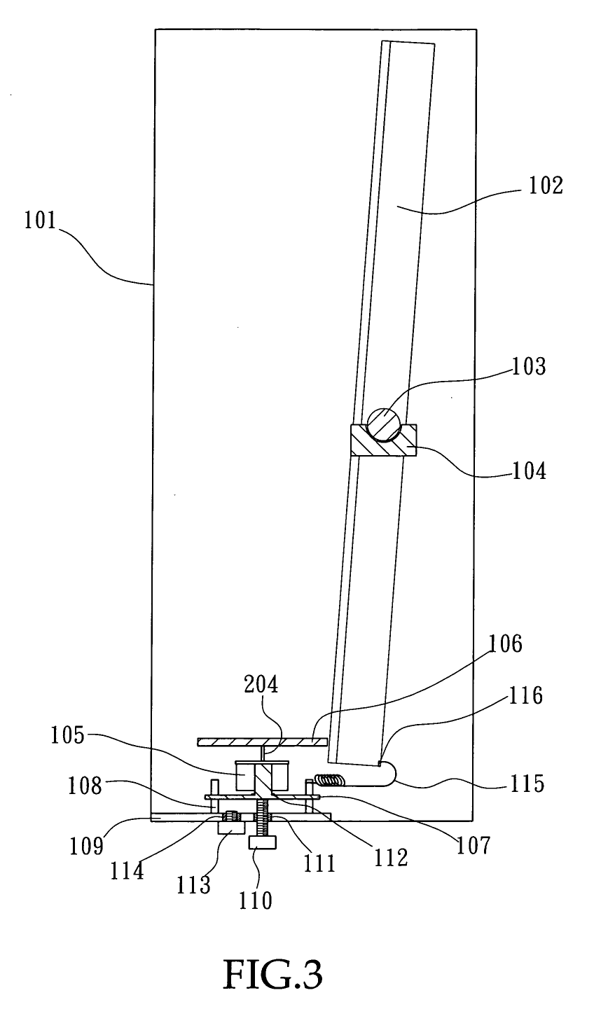

The first embodiment: being applied to an advertisement billboard, referring to FIGS. 2 and 3, the present invention has a framework 101 for an advertisement billboard, the framework 101 (a lateral side of the framework 101 is shown in FIG. 3), the framework 101 has therein semicircle recessed supporting seats 104 each fixed on one of two inner lateral sides of the framework 101 and has a grating plate 102 carrying a picture sheet (wherein the picture sheet contains two pictures to be completely presented by means of the grating plate 102), at the middle of the grating plate 102, a clamping means with a round axle 103 is provided at each of two sides of the grating plate 102; the two round axles 103 are provided each with a bearing (not shown), the two round axles 103 of the grating plate 102 are placed in the semicircle recessed supporting seats 104 of the framework 101, the grating plate 102 is naturally hung on the supporting seats 104; such a mechanical structure can allow a grating plate of even a larger size to have its angular position changed with a minimum external force, then a spring 115 on a cylindrical column on a movable base seat 108 is provided to hook a hole 116 on the bottom of the grating plate 102 in order that the grating plate 102 always clings on the edge of a fan shaped leaf 106. The center of the fan shaped leaf 106 is mounted on a protruding rotating axle 204 of a motor 105; the motor 105 is fixed on a movable plate 107 having four holes on its periphery; a conductor connecting with the motor is extended through the framework 101 to the outside (not shown); the four holes of the movable plate 107 are slipped over four cylindrical columns on the movable base seat 108 which is fixed thereon with two nuts 111, 114 and is mounted in two protruding rails 109 on the bottom of the framework 101 to limit its direction of movement. A movable screw 110 is extended from outside of the bottom of the framework 101 through a rectangular hole (not shown) of the framework 101 to be locked in the nut 111 of the movable base seat 108, and then is extended through a “C” shaped ring 112 to have the tailing end of the movable screw 110 gripped. If an initial angular position of the grating plate 102 before activating the motor is not a correct completely presenting angular position for any of the pictures, the movable screw 110 moves the fan shaped leaf 106 upwards or downwards, and changes the angular position of the grating plate 102 to adjust the initial angular position of the grating plate 102 to be the best angular position to make one of the pictures completely present. Another screw 113 also is extended from outside of the bottom of the framework 101 through the rectangular hole (not shown) of the framework 101 to be locked in the nut 114 of the movable base seat 108; the screw 113 has two functions: Firstly, it can control the base seat 108 to move forwards or rearwards, and in turn control the fan shaped leaf 106 to move forwards or rearwards to adjust the initial angular position of the grating plate 102 to be the best angular position. Secondly, after the aforesaid two ways of adjusting get the best the initial angular position of the grating plate 102, the movable base seat 108 can be fixed on the framework 101 just by locking tight the screws 110 or 113. Wherein the fan shaped leaf 106 is composed of two or more than two semicircles of different radii or non semicircular shapes all with same center, its center is extended through with the rotating axle 204 of the motor 105. The nature of the leaf 106 will be narrated hereinafter.

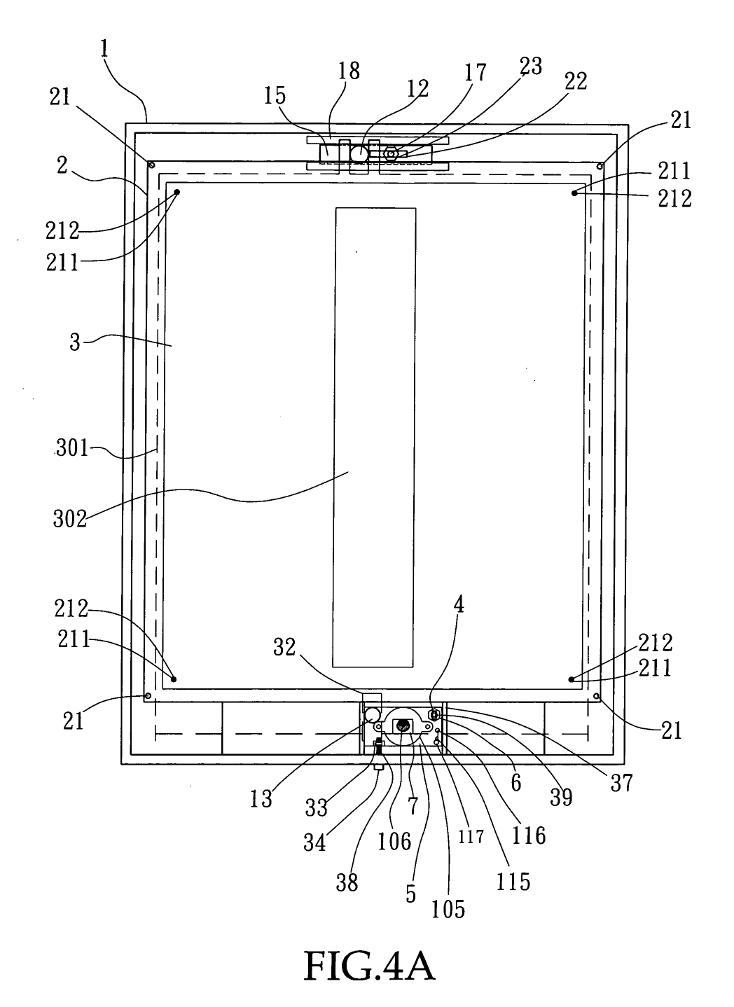

The second embodiment: being applied to a picture frame, the embodiment has three main elements including a framework, a back plate and a tripod, and mainly has improvement on the back plate; referring to FIGS. 4A and 4B; the back plate 1 has therein a recessed space, and has on its upper end a slide plate 15; the slide plate 15 is mounted in two protruding rails 18 on the main body of the back plate 1 to limit its direction of movement, and is provided with a protruding cylindrical column 12; a fixing nut 23 allows a screw 17 to be extended from outside of the bottom of the main body of the back plate 1 through a rectangular hole 22 of the back plate 1 and to be locked in the nut 23. The main body of the back plate 1 totally has four protruding cylindrical columns 21 at four corners of it in order to support a grating plate 2 to keep a suitable distance from a picture sheet 3 below (wherein the picture sheet 3 contains two pictures to be completely presented by means of the grating plate 2); further there are four shorter protruding cylindrical columns 211 provided near and inwardly of the four protruding cylindrical columns 21, for each of the protruding cylindrical columns 211 a movable screw 212 is locked thereon to support the plain plate 301 for sticking thereon with a picture sheet, the picture sheet 3 are stuck with a double sided adhesive tape 302 onto the plain plate 301 sticking with the picture sheet; the back plate 1 has on its bottom end a recessed area (not shown) for mounting therein with a movable plate 5 which is mounted in two protruding rails 37 fixed on the main body of the back plate 1 to limit its direction of movement; the movable plate 5 is fixed thereon with a motor 105, a power line connecting with of the motor 105 is extended through the main body of the back plate 1 to the outside (not shown), the center of a fan shaped leaf 106 is mounted on a protruding rotating axle of the motor 105 (not shown), the movable plate 5 is fixed thereon with an upright nut 33 which is locked therein with a screw 34 extended through a lateral side of the main body of the back plate 1 from outside, a “C” shaped ring 38 grips the screw 34 inside of the lower side of the back plate 1, the movable plate 5 further is fixed thereon with a laid flat nut 6 which is locked therein with a screw 39 extended through a rectangular hole 4 on the bottom of the main body of the back plate 1 from outside; the movable plate 5 further is provided thereon with a protruding cylindrical column 13 and a protruding cylindrical column 117 which is slipped over a spring 115; when in assembling, the plain plate 301 sticking with the picture sheet is placed over the four shorter protruding cylindrical columns 211, a notch 31 thereon is slipped over the protruding cylindrical column 12, while a lower slit 32 is slipped over the protruding cylindrical column 13, and a lower hole 7 is slipped over the fan shaped leaf 106 on the rotating axle 204 of the motor 105, the plain plate 301 has on its lower side another lower hole 116 which is hooked with the spring 115 to render the plain plate 301 to keep in a state of always clinging on the edge of the fan shaped leaf 106; then the grating plate 2 is placed over the picture sheet 3 to be supported by the four protruding cylindrical columns 21, and to be unmoved by tightly and fixedly clamping by the edges of the main body of the back plate 1; at this time, by micro-adjusting leftwards or rightwards of the screw 17 at an outer position on the bottom of the back plate 1, the angular position of the picture sheet 3 can be changed. When specific veins on the picture sheet 3 are parallel to those of the grating plate 2, the picture sheet 3 gets its correct angular position, now the screw 17 can be tightened, and the screw 34 on the lower outer side of the back plate 1 can move the fan shaped leaf 106 to change the angular position of the picture sheet 3 to render a first one of the pictures to be at a correct angular position to completely presenting the picture on the grating plate 2; and after adjustment, the screw 39 on the bottom outer side of the back plate 1 can be tightened. If the tightness of contact of the picture sheet 3 with the grating plate 2 is not appropriate, the height of the movable screws 212 on the protruding cylindrical columns 211 can be micro adjusted, the picture sheet 3 and the grating plate 2 can be kept in the best tightness. The fan shaped leaf 106 is composed of two or more than two semicircles of different radii or non semicircular shapes all with same center, the center of the fan shaped leaf 106 is extended through by the protruding rotating axle of the motor 105; the nature of the leaf 106 will be narrated hereinafter.

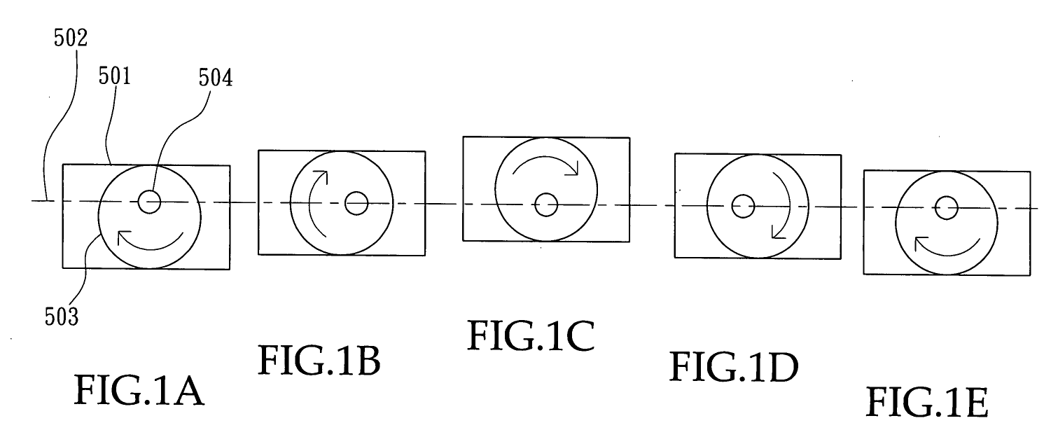

The picture frame and the advertisement billboard for changing of multiple pictures of the present invention are different from a conventional picture frame structurally in three aspects: First, the tailing end of a motor of the conventional picture frame for changing of pictures is fixed thereon with a round pushing leaf (please refer to FIG. 1A, numeral 503) at the center of an eccentrically rotating axle, the picture sheet will move to and fro by displacement induced by rotating of the round pushing leaf at the center of an eccentrically rotating axle. Second, the motor of a conventional picture frame for changing of pictures is fixed on a base of the picture frame, there is no designing for adjustment of moving. Third, there is no designing for adjustment of moving to adjust tightness between a picture sheet and the grating plate of the conventional picture frame.

The features of the designing for adjustment of position moving of the fan shaped leaf 106 and the motor 105 are described below.

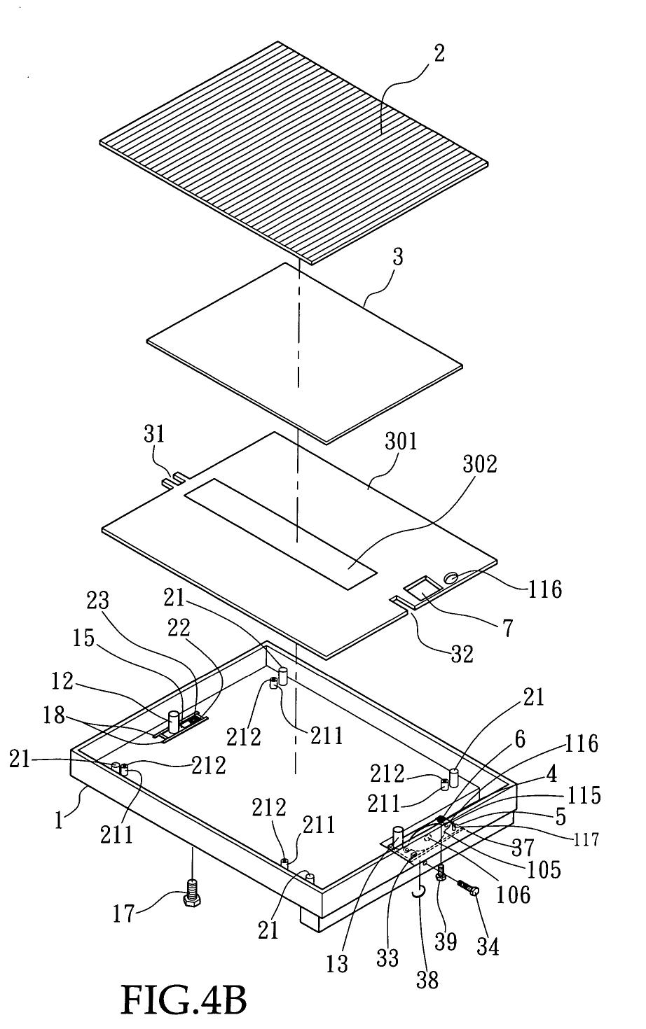

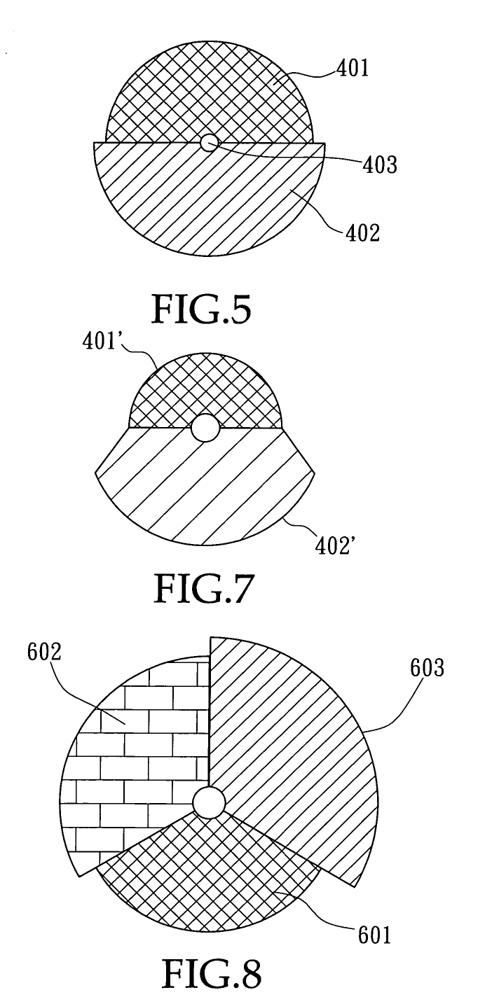

Referring to FIG. 5 which shows a fan shaped leaf for a picture frame for changing of two pictures of the present invention; the fan shaped leaf is composed of a semicircle 401 of a smaller radius and a semicircle 402 of a larger radius both with the same center 403 which is used to assemble with a rotating axle 204 of a motor. This specific designing can allow different pictures on a grating plate to change in a shortest time period, so that the times for entirely presenting the different pictures are lengthened. Referring to FIGS. 6A-6E which are schematic views showing the operations of changing pictures of the leaf 106 of the present invention in rotating and pushing the picture sheet or the grating plate for the above stated two embodiments (namely the grating plate 102 with the picture sheet of the first embodiment or the picture sheet 3 on the plain plate 301). Wherein the picture sheet or the grating plate before activating of the motor is in a state of clinging on the edge of the fan shaped leaf 106; and the position where the smallest arc of the leaf 106 contacts the picture sheet or the grating plate is the initial position, assuming that this is exactly the best angular position to make one of the pictures completely present. FIG. 6B depicts that the picture sheet or the grating plate is kept unmoved when the motor is rotated clockwise for 136 degrees, this means that one of the pictures completely presents during this time period; FIG. 6C depicts that the motor further is rotated for 22 degrees, we can see that the picture sheet or the grating plate is pushed upwards for a small distance “t” by the fan shaped leaf 106 during this transient time period, this distance “t” is exactly the difference between the radii of the two semicircles 401, 402 (referring to FIG. 5); assuming that this difference making a change of angular position is exactly for completely presenting of the other picture on the grating plate. FIG. 6D depicts that the motor further is rotated for 180 degrees, the picture sheet or the grating plate is kept unmoved during this time period, this means that this other one of the pictures completely presents all the way during this time period; FIG. 6E depicts that the motor further is rotated for 22 degrees to return to the starting point, this is also a transient time period for changing the other picture on the grating plate to the first one of the pictures, in which the fan shaped leaf 106 renders the picture sheet or the grating plate to move down for a small distance “t” too.

In comparison among FIGS. 1-6, we can see how large the difference is between the present invention and the conventional technical structure in their effects.

The difference between the radii of the two semicircles 401, 402 of the fan shaped leaf 106 are related to the changing of position or angular position of the picture sheet or the grating plate, well adjusting of the difference between the radii of the two semicircles 401, 402 can solve the problem of changing of position or angular position in changing the first one of the pictures to the other picture on the picture sheet or the grating plate, thus the assuming for FIG. 6C can be achieved by adjustment. To enlarge or reduce the lengths of the peripheries of the two semicircles 401, 402 not equal proportionally can change the times for complete presenting of the two pictures on the grating plate.

The fan shaped leaf 106 is not limited to be composed of two semicircles; it can be specifically designed to be composed of two or more than two semicircles or non semicircular shapes but with same center.

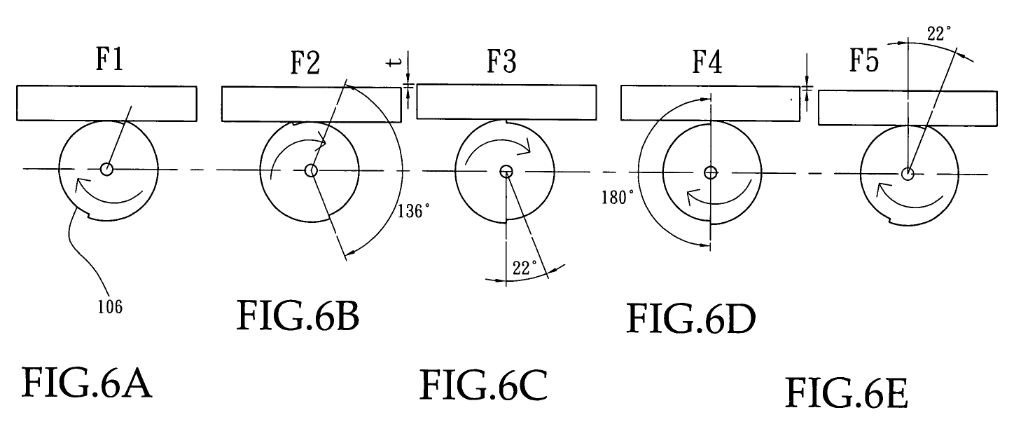

To know how the two pictures have same complete presenting times, referring to FIG. 7, a specific fan shaped leaf 106 is composed of a semicircle 401′ of a smaller radius and a semicircle 402′ of a larger radius, wherein the length of arc of the semicircle 402′ of the larger radius is designed to be in an appropriate proportion to the semicircle 401′ of the smaller radius, and the times for complete presenting of the first one of the pictures and the other picture on the grating plate can be same.

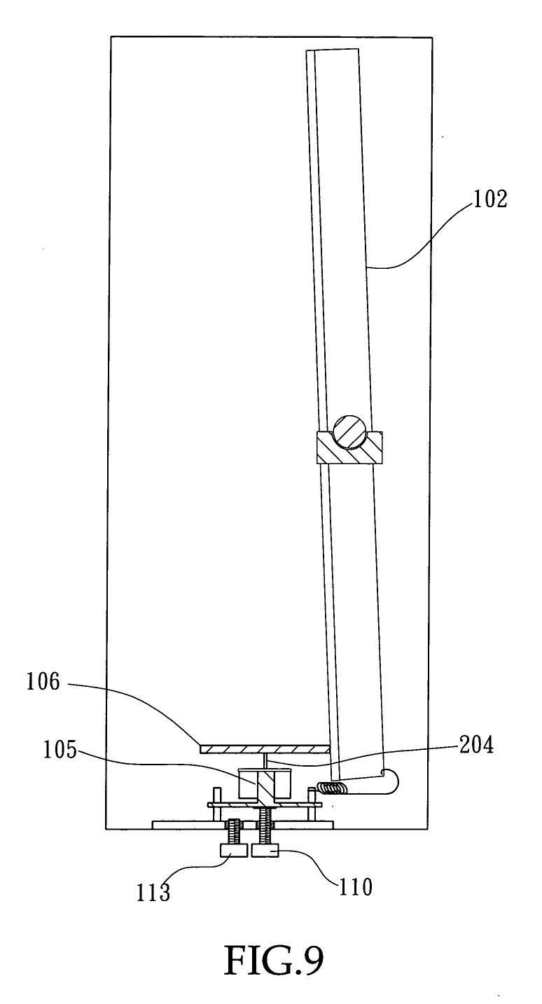

If the grating plate 102 or the picture sheet 3 includes three different pictures, in order to make the three pictures have same complete presenting times, referring to FIG. 8, the fan shaped leaf 106 is composed of three sections 601, 602 and 603 of circles with different radii and of non semicircular shapes but with same center, however, the lengths of arcs of the three sections 601, 602 and 603 are in an appropriate proportion to one another, thus the times for complete presenting of the pictures can be same (each length of arc controls presenting of a picture on the picture sheet 3).

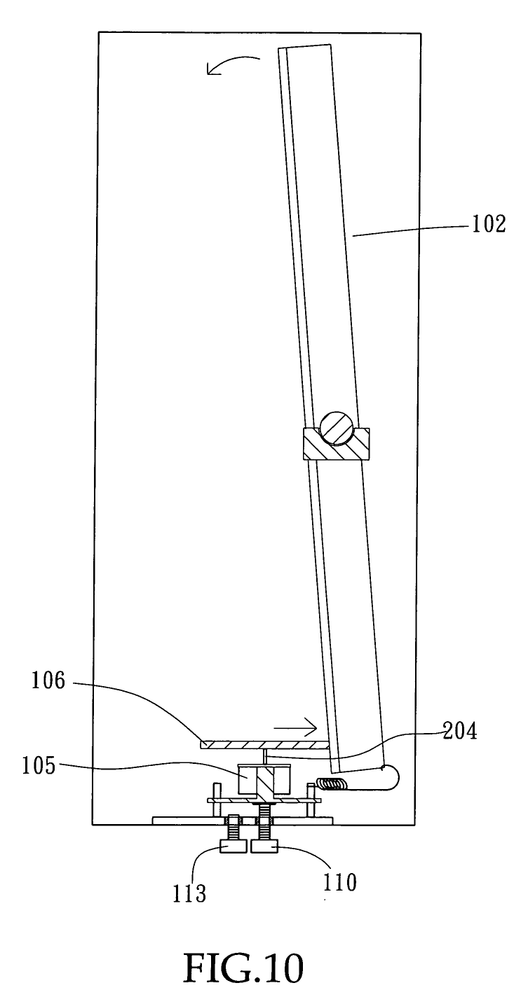

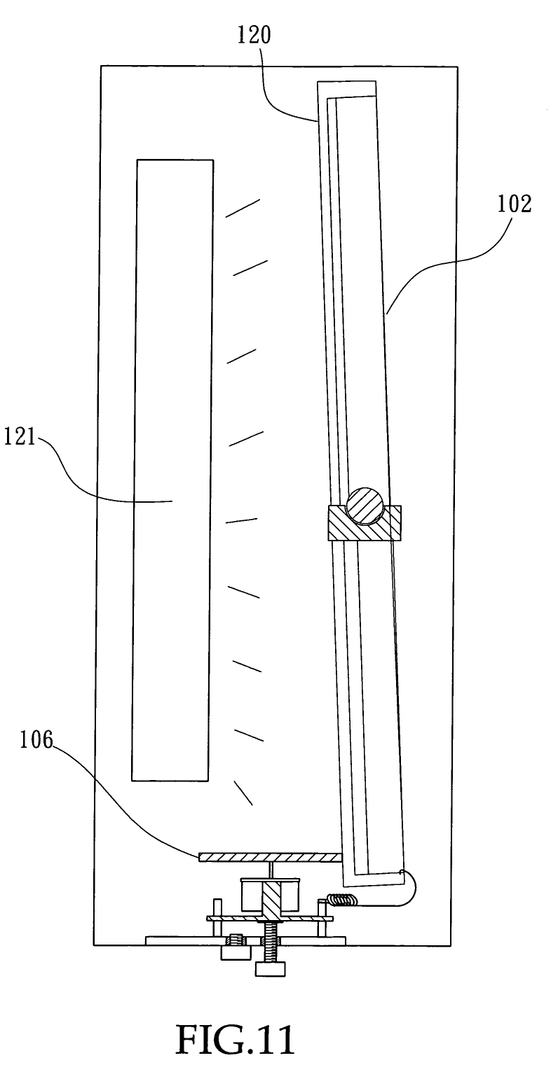

And as to the part of designing for adjustment of position moving of the motor 105: the designing is for solving the problem resulted by different refraction angles of different grating plates, referring to FIG. 9, the end of the grating plate 102 placed on the bottom of the framework clings on the edge of a specific shaped leaf 106; if the first or the second picture on the grating plate 102 in such an angular position is exactly in the angular position for cross changing of the two pictures, a movable screw 110 is adjusted to make the motor 105 get higher or lower, and a movable screw 113 is adjusted to move the motor 105 forwards or rearwards; when the motor 105 is adjusted to move higher or forwards, the specific shaped leaf 106 will push the grating plate 102 rightwards to change the angular position of the grating plate 102, such as is shown in FIG. 10, presenting of the pictures on the grating plate 102 will naturally change, it needs only to adjust to make one of the pictures be in the state of complete presenting, this action can make the assuming for FIG. 6A be achieved by adjustment.

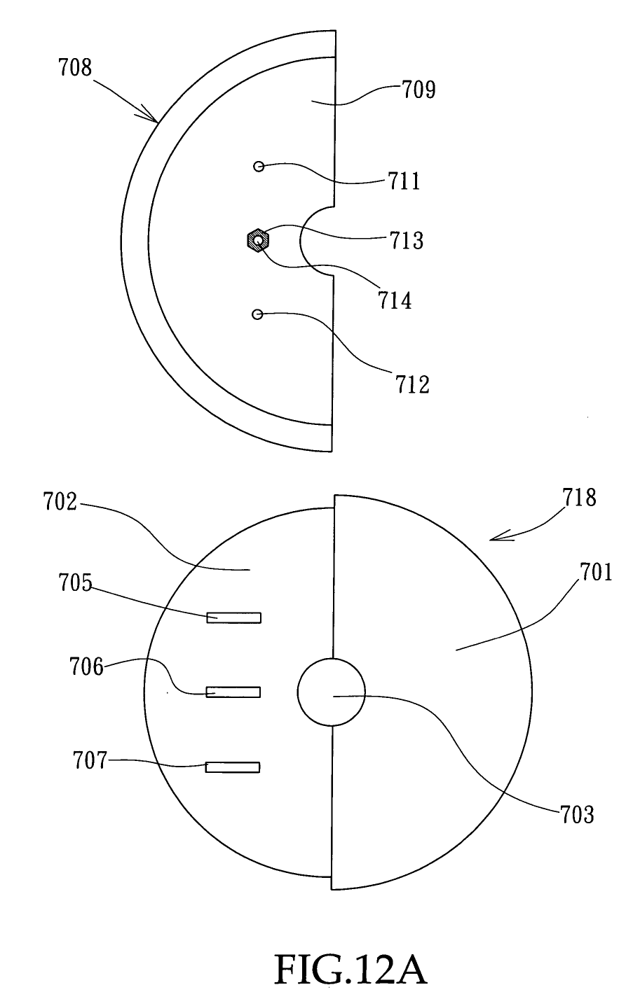

In another embodiment of advertisement billboard shown in FIG. 11 which is a large scale advertisement billboard and is harder to get good evenness in use, wherein four edges and a back side of a grating plate 102 are framed by a framework 120, a fan shaped leaf 106 contacts the framework 120 to move the grating plate 102, the front surface of the framework 120 can be mounted with a transparent glass or plastic panel with better evenness to press flat the grating plate 102 to be fixed by the framework 120.

Certainly, light emitting elements can be installed under the picture sheet in a picture frame or an advertisement billboard, such as is depicted in FIG. 11 having a light emitting element 121 which is suitable for use at night or in the dark, these all fall into the scope of the present invention.

The fan shaped leaf 106 mounted on the protruding rotating axle 204 of the motor 105 can be a fixed type or a detachable type.

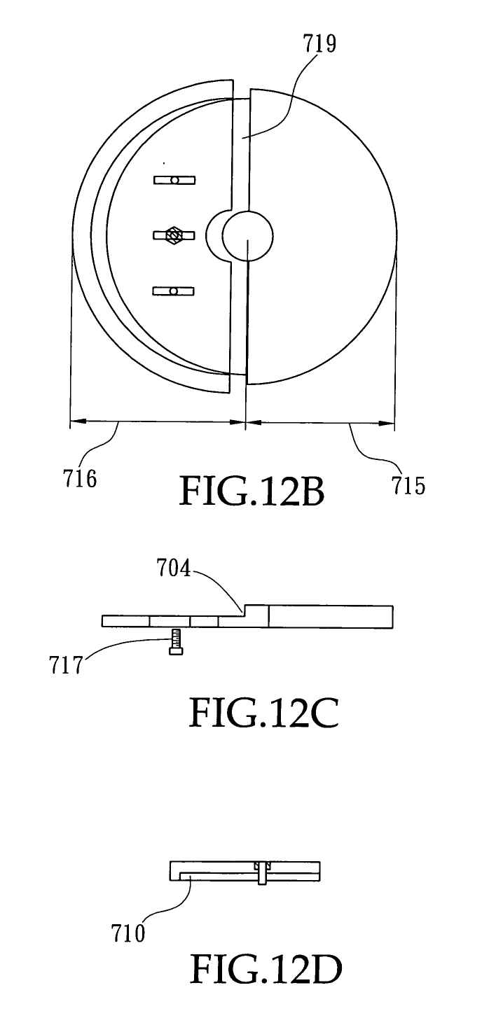

Referring to FIGS. 12A and 12B, wherein a fan shaped leaf can be a separable movable and adjustable type; a main leaf 718 is composed of a thicker and larger semicircle 701 and a thinner and smaller semicircle 702 with the same center 703 which is used to fix a rotating axle 204 of a motor; the larger semicircle 701 is designed to be thicker than the smaller semicircle 702, the two semicircles 701, 702 are formed therebetween a step 704 as shown in FIG. 12C; and the smaller semicircle 702 has thereon three rectangular holes 705, 706 and 707.

A secondary leaf 708 with a thickness same as that of the larger semicircle 701 of the main leaf 718 is semicircular, it has thereon a recessed semicircle 709 with a radius equal to that of the smaller semicircle 702 of the main leaf 718; the recessing thickness of the recessed semicircle 709 equals to that of the smaller semicircle 702 of the main leaf 718, thereby a step 710 is formed as shown in FIG. 12D; the recessed semicircle 709 has thereon two downwardly protruding cylindrical columns 711, 712 and a fixed nut 713 having therein a hole 714.

When in assembling, the two protruding cylindrical columns 711, 712 on the secondary leaf 708 are respectively slipped into the first and the third rectangular holes 705 and 707; another movable screw 717 (referring to FIG. 12C) is extended through the second rectangular hole 706 on the bottom of the main leaf 718 to lock into the fixed nut 713 of the secondary leaf 708. At this time, the secondary leaf 708 is slidable; if the difference between it and the main leaf 718 is not correct, the secondary leaf 708 can be micro-adjusted to an appropriate position and then the movable screw 717 is locked, as shown in FIG. 12B; and this is a complete fan shaped leaf of the separable movable and adjustable type.

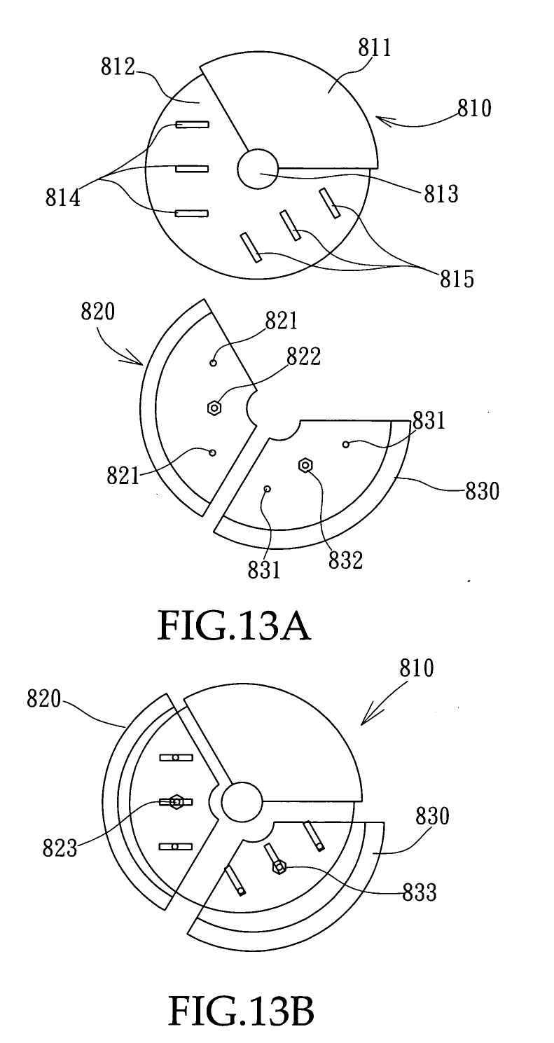

FIGS. 13A and 13B depict a structure of a separable triple fan shaped leaf with different radii; it is composed of a main leaf 810, a secondary leaf 820 and another secondary leaf 830.

The main leaf 810 is in the shape of a fan composed of a thicker sector 811 and a thinner sector 812, the sectors have a central round hole 813 connectable with a protruding rotating axle of a motor; and the thinner sector 812 is provided with two rectangular hole groups 814, 815. The thickness of each of the two secondary leaves 820, 830 is same as that of the difference between the thicker sector 811 and the thinner sector 812; the two secondary leaves 820, 830 are assembled on the thinner sector 812; the two secondary leaves 820, 830 have respectively down protruding cylindrical columns 821, 831 insertable respectively into the two rectangular hole groups 814, 815 of the main leaf 810. The two secondary leaves 820, 830 are provided thereon respectively with nuts 822, 832 for locking therein of screws 823, 833 extending through the rectangular hole groups 814, 815, so that the two secondary leaves 820, 830 are fixed on the main leaf 810 to form the entire triple fan shaped leaf. The principle of adjusting and fixing is the same of that of the dual fan shaped leaf 106.

In conclusion, the brand-new structure of a display frame for changing of multiple pictures provided by the present invention can surely achieve the expected object thereof to get the effect that the pictures are entirely presented in prolonged times.

Having thus described the technical structure of my invention with practicability and improvement,

What I claim as new and desire to be secured by Letters Patent of the United States is:

1. A display frame for changing of multiple pictures, said display frame at least comprises in an assembly a framework, a picture sheet, a grating plate and a movably mounted motor; said picture sheet includes therein at least two pictures, said picture sheet and the grating plate are assembled in said framework, a leaf of specific fan shape is driven by said motor to change positions or angular positions of said picture sheet and said grating plate, thereby said pictures of said picture sheet on said grating plate are adapted to automatically changing and entirely presenting in prolonged times; said display frame is characterized in that:
said specific fan shaped leaf is composed of two or more than two semicircles of different radii or non semicircular shapes all with same center, when a rotating axle of said motor drives said specific fan shaped leaf to rotate, lengths of arcs of said specific fan shaped leaf of different radii change positions or angular positions of said grating plate, thereby effects that said pictures on said grating plate are alternately changed and entirely presented in prolonged times are achieved.

2. The display frame for changing of multiple pictures as claimed in claim 1, wherein said fan shaped leaf includes those lengths of arcs of said two or more than two semicircles or non semicircular shapes all with same center, sizes of said lengths of arcs are adapted to being enlarged or reduced in equal proportion or non equal proportion.

3. The display frame for changing of multiple pictures as claimed in claim 1, wherein said fan shaped leaf is made of plastic or metal.

4. The display frame for changing of multiple pictures as claimed in claim 1, wherein said specific fan shaped leaf mounted on said rotating axle of said motor is an integral type or a combination type.

5. The display frame for changing of multiple pictures as claimed in claim 1, wherein said display frame is a picture frame which has a framework, a back plate and a tripod, said grating plate and said picture sheet are separately mounted in said framework, said picture sheet are placed a suitable distance under said grating plate after being stuck onto a movable plain plate, said grating plate is unmoved because of said framework structurally, a notch on an upper end of said plain plate is slipped over a protruding cylindrical column on a slide plate in said back plate, a fixing nut is provided on said slide plate and is locked therein with a screw which is extended through said back plate from outside of said back plate; said screw is tightened after angular position of said picture sheet is well adjusted, said motor is fixed on a movable plate on a lower side in said framework, said rotating axle of said motor is connected with a center of said specific fan shaped leaf, a lower hole on a lower side of said plain plate is slipped over said fan shaped leaf, a lower slit is slipped over a protruding cylindrical column of said movable plate, another lower hole is hooked with a spring on another protruding cylindrical column of said movable plate to render said plain plate to keep in a state of always clinging on an edge of said fan shaped leaf.

6. The display frame for changing of multiple pictures as claimed in claim 5, wherein position of said motor fixed on said movable plate is adjusted with two screws extended through said framework from outside, said motor is adjusted to adjust an initial angular position of said grating plate to make one of said pictures completely present.

7. The display frame for changing of multiple pictures as claimed in claim 5, wherein said movable plate fixed thereon with said motor is mounted in two protruding rails on a bottom of said framework to limit its direction of movement.

8. The display frame for changing of multiple pictures as claimed in claim 5, wherein a main body of said back plate has four protruding cylindrical columns at four corners of it in order to support said grating plate to keep a suitable distance of it from said picture sheet below; further there are four shorter protruding cylindrical columns provided near and inwardly of said four protruding cylindrical columns, for each of said protruding cylindrical columns a movable screw is locked thereon to support said plain plate for sticking thereon with said pictures, if tightness of contact of said picture sheet with said grating plate is not appropriate, height of said movable screws on said protruding cylindrical columns is micro adjusted, said picture sheet and said grating plate thus is kept in the best tightness.

9. The display frame for changing of multiple pictures as claimed in claim 1, wherein power equipment is provided for said motor, said power equipment at least includes a power line, a transformer and a switch.

10. The display frame for changing of multiple pictures as claimed in claim 1, wherein lengths of arcs of said two or more than two semicircles of different radii or non semicircular shapes all with same center of said specific fan shaped leaf are kept to be in appropriate proportions to one another in order to make each of said pictures have same complete presenting times.

11. The display frame for changing of multiple pictures as claimed in claim 1, wherein light emitting elements and elements including transformers, voltage stabilizers and circuit control boards etc. required by said light emitting elements are installed in said back plate of said picture frame or said framework of said advertisement billboard.

12. The display frame for changing of multiple pictures as claimed in claim 1, wherein two semicircle recessed supporting seats are fixed inside and at the middle of said framework, said grating plate has thereon said picture sheet and is fixedly provided at two sides thereof with two clamping means each having a round axle, said two round axles are placed in said two semicircle recessed supporting seats inside of said framework, thus said grating plate is naturally hung on said supporting seats, a spring connected to a movable base seat is provided to hook a bottom of said grating plate in order that said grating plate always clings on an edge of said fan shaped leaf; when said fan shaped leaf is rotated by said motor, it changes an angular position of said grating plate.

13. The display frame for changing of multiple pictures as claimed in claim 12, wherein said center of said fan shaped leaf is mounted on said protruding rotating axle of said motor; said motor is fixed on a movable plate having four holes on its periphery; said four holes of said movable plate are slipped respectively over four cylindrical columns on said movable base seat which is fixed thereon with two nuts and is mounted in two protruding rails on a bottom of said framework to limit its direction of movement; a movable screw is extended from outside of said bottom of said framework through a rectangular hole of said framework to be locked in one of said nuts of said movable base seat, and then is extended through a “C” shaped ring to have a tailing end of said movable screw gripped; if an initial angular position of said grating plate before activating said motor is not a completely presenting angular position for any of said pictures, said movable screw is rotated to move said fan shaped leaf upwards or downwards, and changes said angular position of said grating plate to adjust said initial angular position of said grating plate to be the best angular position to make one of said pictures completely present.

14. The display frame for changing of multiple pictures as claimed in claim 13, wherein another one of said nuts is locked therein with another screw extended from outside of said bottom of said framework through said rectangular hole of said framework, this controls said base seat to move forwards or rearwards, and in turn controls said fan shaped leaf to move forwards or rearwards to adjust said initial angular position of said grating plate to get the best function of said initial angular position, or this makes said movable base seat be fixed on said framework by locking tight said screw after said grating plate is adjusted to get its best initial angular position.

15. The display frame for changing of multiple pictures as claimed in claim 12, wherein said movable plate and said movable base seat are made of plastic or metal.

16. The display frame for changing of multiple pictures as claimed in claim 12, wherein four edges and a back side of said grating plate are framed by another framework, a front surface of said framework is mounted with a transparent glass or plastic panel to press flat said grating plate to be fixed by said another framework, said fan shaped leaf contacts said another framework to move said grating plate to change angular position of said grating plate.

17. The display frame for changing of multiple pictures as claimed in claim 4, wherein said fan shaped leaf is a combination type, it comprises:
a main leaf composed of a thicker and a thinner sector with same center used to fix said rotating axle of said motor; said smaller sector has thereon at least a group of rectangular holes; and
at least a secondary leaf with a thickness same as that of a difference between said thicker sector and said thinner sector; said secondary leaf has a down protruding cylindrical column adapted to inserting into one of said group of rectangular holes of said main leaf, and is provided thereon with a nut for locking therein of a screw extending through another of said group of rectangular holes, so that said secondary leaf is fixed on said main leaf to form said fan shaped leaf.

18. The display frame for changing of multiple pictures as claimed in claim 17, wherein said main leaf has thereon three rectangular holes, while two protruding cylindrical columns are provided on said secondary leaf and are adapted to inserting respectively into a first and a third one of said three rectangular holes, said screw is extended through a second one of said three rectangular holes to lock in said nut of said secondary leaf.

19. The display frame for changing of multiple pictures as claimed in claim 17, wherein said fan shaped leaf has two secondary leaves, said main leaf has thereon two groups of rectangular holes; said two secondary leaves are provided thereon each with a nut for locking therein of a screw extending through one of said two groups of rectangular holes, so that said two secondary leaves are fixed on said thinner fan of said main leaf.

20. The display frame for changing of multiple pictures as claimed in claim 1, wherein said grating plate is formed by sticking a cylindrical mirror grating plate or a printed grating film onto a transparent plate.
